(19) United States
(12) Patent Application Publication
(10) Pub. No.: US 2024/0181995 A1
(43) Pub. Date: Jun. 6, 2024

(54) DEVICE FOR CLEANING AN OPTICAL SURFACE

(71) Applicants: UNIVERSITE DE LILLE, Lille (FR); CENTRALE LILLE INSTITUT, Villeneuve D'ascq Cedex (FR); UNIVERSITE POLYTECHNIQUE HAUTS-DE-FRANCE, Valenciennes (FR); Centre National de la Recherche Scientifique, Paris (FR); Valeo Systèmes d'Essuyage, Le Mesnil Saint Denis (FR)

(72) Inventors: Michaël Baudoin, Lezennes (FR); Ravinder Chutani, Ronchin (FR); Olivier Bou Matar-Lacaze, Lille (FR); Frederic Bretagnol, Le Mesnil Saint Denis (FR); Vincent Izabel, Le Mesnil Saint Denis (FR); Gérald Caillot, Le Mesnil Saint Denis (FR); Alexandre Filloux, Le Mesnil Saint Denis (FR)

(73) Assignees: UNIVERSITE DE LILLE, Lille (FR); CENTRALE LILLE INSTITUT, Villeneuve D'ascq Cedex (FR); UNIVERSITE POLYTECHNIQUE HAUTS-DE-FRANCE, Valenciennes (FR); Centre National de la Recherche Scientifique, Paris (FR); Valeo Systèmes d'Essuyage, Le Mesnil Saint Denis (FR)

(21) Appl. No.: 18/285,202

(22) PCT Filed: Mar. 29, 2022
(86) PCT No.: PCT/EP2022/058327

§ 371 Date: Sep. 29, 2023

(30) Foreign Application Priority Data
Mar. 31, 2021 (FR) 2103337

(51) Int. Cl. B60S 1/52; G02B 27/00

(52) U.S. Cl. CPC B60S 1/52; G02B 27/0006

(57) ABSTRACT

The invention relates to a device (5) comprising an optical surface (10) and a cleaning device (15) for cleaning the optical surface comprising:— a wave transducer (25) acoustically coupled with the optical surface and configured to synthesize an ultrasound wave (W) propagating within the optical surface, and— a spraying unit (20) for dispensing a washing liquid (L) onto the optical surface, the device being shaped so that the ultrasound wave displaces the washing liquid on the optical surface.

The present invention relates to a device for cleaning an optical surface.

In various fields, it is necessary to overcome the effects associated with the build-up of dirt on an optical surface.

Dirt, for example dust, particles of dried mud or greasy films, hinders the clear view of an observer looking at their surroundings through the optical surface or detection by a system configured to emit or receive radiation through the optical surface.

To clean dirt that has built up on a windshield, it has long been known practice to spray a washing liquid onto the windshield, then extend the layer formed by the washing liquid sprayed in this way over the windshield by means of the back and forth movement of one or more wiper blades. The friction of the wiper blades in contact with the windshield makes it possible to evacuate the dirt dispersed in the washing liquid from the optical surface. This does however have the drawback of spreading the dirt over the optical surface before it is dispersed in the washing liquid. Furthermore, it is generally necessary to provide large amounts of washing liquid to evacuate the dirt.

To clean the dirt covering the optical surface that protects an optical sensor intended for an autonomous vehicle, for example, FR 3 056 524 A1 describes a device comprising a distribution manifold that can be moved relative to the vertical optical surface. A washing liquid is sprayed through the displacement of the distribution manifold, which is kept at a distance from the optical surface. After a predetermined amount of washing liquid has been sprayed and evacuated under the effect of gravity once dirtied by the dirt, dry air is sprayed onto the droplets of washing liquid remaining in contact with the optical surface. However, such drying leaves a dirty film formed by the dirt contained in the droplets that are redeposited on the optical surface. In addition, the device in FR 3 056 524 A1 has a relatively large footprint as it requires the implementation of telescopic members to move the distribution manifold away from the optical surface. Furthermore, the washing liquid is sprayed at high pressure in order to evacuate the dirt efficiently. Finally, it is not suitable for cleaning large surfaces. Another example of a telescopic cleaning device for a glazed surface of a sensor is described in FR 3 096 944 A1.

There is therefore a need to overcome the aforementioned drawbacks.

The invention aims to at least partially meet this need, and proposes a device comprising an optical surface and an apparatus for cleaning the optical surface comprising:
a wave transducer acoustically coupled to the optical surface and configured to synthesize an ultrasonic wave propagating in the optical surface, and
a spraying unit for delivering a washing liquid onto the optical surface, the device being configured so that the ultrasonic wave displaces the washing liquid on the optical surface.

The device according to the invention allows simple, effective cleaning of the optical surface. In particular, setting the washing liquid in motion under the action of the ultrasonic wave facilitates the spreading on the optical surface of the layer formed by the liquid. It further makes it possible to efficiently evacuate the dirty water from the optical surface. The droplets of dirty washing liquid clinging to the optical surface under the action of capillary forces can easily be evacuated. The reforming of a dirty film on the optical surface as a result of the evaporation of the residual washing liquid can thus be avoided.

### Spraying Unit

The spraying unit is preferably superposed on the transducer.

The transducer is preferably arranged between the spraying unit and the optical surface. At least one portion of the transducer can thus be protected against an impact. The spraying unit can particularly completely cover one face of the transducer.

Preferably, the spraying unit is configured to deliver the washing liquid onto a zone of the optical surface situated on the propagation path of the ultrasonic wave. The washing liquid can thus be displaced under the action of the ultrasonic wave as soon as it comes into contact with the optical surface.

Preferably, the spraying unit comprises a channel for supplying washing liquid at least partially superposed on the transducer and distant less than 4 cm, preferably less than 2 cm, preferably less than 1 cm, from the transducer. Advantageously, the washing liquid can be heated when it passes through the supply channel by the heat dissipated by the transducer when the ultrasonic wave is generated. For example, in winter conditions, the device according to the invention can facilitate the defrosting of the solidified washing liquid contained in the supply channel. In summer conditions, the effectiveness of the cleaning of the optical surface is increased by the heating of the washing liquid by the heat dissipated by the transducer.

Preferably, the cleaning apparatus comprises a thermal diffusion member, arranged between the transducer and the spraying unit, made from a material having thermal conductivity greater than or equal to 50 W.m⁻¹.K⁻¹, preferably greater than or equal to 150 W.m⁻¹.K⁻¹, for example a copper alloy, in order to optimize the thermal transfer of the heat produced by the transducer to the supply channel.

The thermal diffusion member can be in contact with the transducer. In one variant, it is apart from the transducer.

The thermal diffusion member is made from a metal material, for example an aluminum alloy.

The thermal diffusion member can take the form of a plate having a thickness of between 0.01 cm and 3 cm, and preferably less than 1 cm.

The cleaning apparatus can extend from one side of the optical surface to the other, preferably between two opposite edges of the optical surface. For example, it extends over the entire width of the optical surface.

The cleaning apparatus can be configured to deliver the washing liquid to different zones of the optical surface and so that the ultrasonic wave displaces the washing liquid over a zone extending from one side of the optical surface to the other.

The cleaning apparatus can comprise a plurality of transducers and the spraying unit can comprise a plurality of supply channels that are each superposed on a corresponding transducer.

For example, the transducers can be arranged evenly spaced apart from each other along one edge of the optical surface and the spraying unit can extend in a strip along said edge.

The cleaning apparatus can be arranged on the periphery of the optical surface. In particular, when the optical surface is inclined, it can be arranged on the upper portion of the optical surface and it can be configured so that the ultrasonic wave propagates substantially in the direction of greatest inclination of the optical surface. The washing liquid can thus be evacuated from the optical surface under the combined action of gravity and the propagation of the ultrasonic surface wave.

In addition, the spraying unit can be configured to deliver the washing liquid sequentially. Sequential delivery makes it possible to avoid the premature evaporation of the washing liquid. The inventors have observed that sequential delivery allows for rapid and particularly effective washing of the optical surface.

In particular, the spraying unit can be configured to deliver the washing liquid in sequences of a duration of between 20 ms and 5 s, the sequences being spaced apart by a duration of between 50 ms and 60 s.

In addition, the spraying unit can be configured to deliver the washing liquid at a relative pressure of less than 1 bar. “Relative pressure” is given to mean the difference between absolute pressure and atmospheric pressure, absolute pressure being measured relative to a reference that is zero in a vacuum. This thus avoids the washing liquid being sprayed after the washing liquid has come into contact with the optical surface. Furthermore, such delivery makes it possible to reduce the amount of washing liquid necessary to clean the optical surface.

The spraying unit can comprise a structure in fluid communication with a sprinkler nozzle. The structure and/or the sprinkler nozzle can define at least one supply channel. The sprinkler nozzle can be movably mounted relative to the structure. Advantageously, the orientation of the sprinkler nozzle can be adjusted to deliver the washing liquid onto a predetermined zone of the optical surface.

Preferably, the spraying unit is rotatably mounted on the structure about at least one axis of rotation. The axis of rotation of the sprinkler nozzle can be contained in a plane parallel to the mid-plane along which the optical surface extends. As a variant, it can be parallel to this mid-plane. The nozzle can have a tubular shape extending along the axis of rotation.

The sprinkler nozzle can comprise at least one or even a plurality of distribution orifices emerging onto the optical surface for delivering the washing liquid.

The apparatus for cleaning the optical surface can comprise a motor for rotating the sprinkler nozzle relative to the structure. The motor can move the nozzle back and forth between two different angular positions. As a variant, the motor can move the sprinkler nozzle to a specific position in which the nozzle is kept immobile relative to the structure. It is thus possible to select the zone of the optical surface onto which the washing liquid is to be delivered.

In addition, the cleaning apparatus can comprise a pump for transferring the washing liquid from a tank to the spraying unit. The pump can be electrically powered. The flow of washing liquid that it is capable of delivering can be proportional to the electric voltage with which it is supplied.

The spraying unit can be secured to the optical surface and/or to the transducer.

Preferably, the spraying unit is immobile relative to the optical surface.

The spraying unit can be removably mounted on the optical surface and/or on the transducer, for example by means of a heat-sensitive adhesive.

### Wave Transducer

The wave transducer is acoustically coupled to the optical surface and is configured to synthesize an ultrasonic wave propagating in the optical surface.

The ultrasonic wave can be a surface wave or a Lamb wave. In particular, it can be a Rayleigh wave when the optical surface has a thickness greater than the wavelength of the ultrasonic surface wave. A Rayleigh wave is preferred because a maximum proportion of the wave energy is concentrated on the face of the optical surface on which it propagates, and can be transmitted to the washing liquid.

The transducer preferably has a thickness of between 1 μm and 500 μm.

The thickness of the transducer is measured normal to the optical surface.

Preferably, the transducer extends from one edge of the optical surface over a distance of less than 25 mm.

The wave transducer can be a contact ultrasonic transducer. To optimize the propagation of the wave from the transducer to the optical surface, an impedance-matched acoustic index transmission gel can be arranged sandwiched between the acoustic transducer and the optical surface. The contact ultrasonic transducer can be arranged at a right angle on the optical surface. Such an arrangement of the transducer is preferred when the optical surface has a thickness less than the wavelength of the ultrasonic surface wave and/or when the ultrasonic wave is a Lamb wave. As a variant, the contact ultrasonic transducer can be arranged so that it forms an angle with the normal to the optical surface that is less than 90° and the value of which can be determined using the Snell-Descartes law.

According to a preferred variant, the transducer comprises two interdigitated comb electrodes with opposite polarity and a substrate made from a piezoelectric material, particularly selected from the group consisting of lithium niobate, aluminum nitride, lead zirconate titanate, and mixtures thereof, the combs being arranged in contact with a substrate.

The comb electrodes can each comprise a connector and fingers that extend from the connector. The substrate can comprise an inactive portion that is not superposed on an assembly delimited by the peripheral fingers of the two combs. This inactive portion of the substrate, together with the connectors, does not contribute to the generation of the ultrasonic wave. It can extend on either side of said assembly delimited by the peripheral fingers of the combs.

A slot can be made between the transducer and the thermal diffusion member and/or between the transducer and the spraying unit, in particular when the thickness of the transducer is less than the wavelength of the ultrasonic wave generated by the transducer and/or when the device is configured to generate a Lamb wave. This avoids the ultrasonic wave being partially or fully absorbed by the thermal diffusion member and/or by the spraying unit and weakly transmitted in the optical surface. Preferably, the slot is superposed on the combs and the thermal diffusion member can be in contact with the inactive portion of the substrate.

Preferably, the slot extends over the entire length of at least one of the opposing faces of the transducer and of the thermal diffusion member. The thickness of the slot can be between 1 nm, in particular 10 nm, and 5 mm.

As a variant, in particular when the thickness of the transducer is greater than the wavelength of the ultrasonic wave generated by the transducer and/or the ultrasonic wave is a Rayleigh wave, the transducer and the thermal diffusion member can be in contact with each other or each be in contact with a connecting layer, for example a heat transfer paste that is sandwiched between the transducer and the thermal diffusion member.

The transducer is preferably in contact with the optical surface.

The transducer can be secured to the optical surface, in particular by means of a polymer adhesive that also acoustically couples the transducer to the optical surface. The adhesive can be UV-curable. It is, for example, an epoxy resin. The transducer can be secured by molecular adhesion or by means of a thin metal layer that provides the adhesion between the optical surface and the transducer. The layer can be made from a metal or an alloy with a low melting point, i.e. having a melting point below 200° ° C., for example an indium alloy. As a variant, the metal layer can be made from a metal or an alloy having a melting point above 200° C., for example an aluminum and/or gold alloy.

The transducer can be configured to emit an ultrasonic surface wave or a Lamb wave with a fundamental frequency that can be between 0.1 MHz and 1,000 MHz, preferably between 10 MHz and 100 MHz, for example equal to 40 MHz, and/or with an amplitude that can be between 1 nanometer and 500 nanometers. The amplitude of the wave corresponds to the normal displacement of the face of the optical surface on which the ultrasonic surface wave propagates. It can be measured using laser interferometry. The amplitude can depend on the frequency of the fundamental wave.

Preferably, the device comprises at least two, for example more than five, or even more than ten transducers.

The transducers can be configured to emit acoustic surface waves that propagate in directions that are parallel or secant. For example, the device comprises at least three transducers that are configured so that the directions of propagation of the waves that they are capable of generating intersect at a common location. Having a plurality of transducers makes it possible to limit the screening and wave scattering effects of each drop of washing liquid.

The transducers can be evenly distributed over the contour of the face of the optical surface on which they are arranged.

### Optical Surface

The device according to the invention advantageously makes it possible to clean a large expanse of the optical surface.

Preferably, the optical surface extends over an area greater than or equal to 1 cm², or even greater than or equal to 100 cm², or even greater than or equal to 400 cm².

The optical surface can be self-supporting, in the sense that it can deform, in particular elastically, without breaking under its own weight.

The face of the optical surface on which the ultrasonic surface wave or the Lamb wave propagates can be planar. It can also be curved, provided that the radius of curvature of the face is greater than the wavelength of the ultrasonic surface wave. Said face can be rough. The rough spots are preferably smaller than the fundamental wavelength of the ultrasonic surface wave, so that they do not significantly affect the propagation thereof.

The optical surface can take the form of a plate that is planar or that has at least one curvature in one direction.

The optical surface preferably has a thin shape. The ratio of the length of the optical surface to the thickness of the optical surface can be greater than 10, or even greater than 100, or even greater than 1,000.

The thickness of the optical surface can be between 0.05 mm and 5 mm, in particular between 0.5 mm and 2.5 mm, and/or the length of the optical surface can be greater than 1 cm, or even greater than 10 cm, or even greater than 20 cm.

“Thickness of the optical surface” refers to the smallest dimension of the optical surface measured in a direction perpendicular to the surface on which the ultrasonic surface wave or the Lamb wave propagates.

The optical surface can be arranged flat relative to the horizontal. As a variant, it can be inclined relative to the horizontal by an angle a greater than 10°, or even greater than 20°, or even greater than 45°, or even greater than 70°. It can be arranged vertically.

The optical surface is preferably optically transparent, in particular to visible light or to ultraviolet or infrared radiation. The device is thus particularly suitable for applications that seek to improve the visual comfort of a user observing their surroundings through the optical surface.

The optical surface can comprise an acoustically conductive portion made from an acoustically conductive material, preferably glass.

The acoustically conductive portion preferably has an attenuation length greater than the length of the optical surface, or even greater than 10 times its length, or even greater than 100 times its length.

The acoustically conductive material can have an elastic modulus greater than 1 MPa, for example greater than 10 MPa, or greater than 100 MPa, or even greater than 1,000 MPa, or indeed even greater than 10,000 MPa. A material having such an elastic modulus has a stiffness particularly suited to the propagation of an ultrasonic surface wave or a Lamb wave.

The optical surface can comprise at least two acoustically conductive portions stacked one on top of the other.

The optical surface can consist of the acoustically conductive portion.

As a variant, the optical surface can comprise an acoustically insulating portion that forms a stack with the acoustically conductive portion, the acoustically insulating and acoustically conductive portions being in contact with each other.

In particular, the acoustically conductive and acoustically insulating portions can be plates stacked one on top of the other. The acoustically insulating portion is preferably transparent.

The acoustically insulating portion can support the acoustically conductive portion. It can have a thickness at least ten times greater than the thickness of the acoustically conductive portion, which is preferably a layer or a multilayer. It can also have a lower surface the area of which is equal to or at least 10 times greater than the acoustically conductive portion.

Preferably, in order to avoid the ultrasonic wave interacting with the acoustically insulating portion, the thickness of the acoustically conductive portion is greater than the wavelength of the ultrasonic surface wave.

In particular, the acoustically insulating portion can be selected from the thermoplastics, in particular polycarbonate, and the acoustically conductive portion can be an acoustically conductive layer or an acoustically conductive multilayer, which can be arranged on the surface of an acoustically non-conductive material, as illustrated for example in the articles Appl. Phys. Lett. 112, 093502 (2018); doi: 10.1063/1.5021663 and Sci Rep 3, 2140 (2013), doi:10.1038/srep02140, incorporated for reference purposes.

A material for forming such a layer or multilayer is for example selected from the materials for forming an anti-UV layer and/or an anti-scratch layer of a polycarbonate windshield. It can be a “glass-like” material, that is, having optical and mechanical properties of glass.

The acoustically insulating portion can have an attenuation length of the ultrasonic wave at least ten times less than its length.

The area of the acoustically insulating portion can be greater than the area of the acoustically conductive portion.

For example, the acoustically insulating portion can be a glazed element of a motor vehicle, for example a windshield, for example made from polycarbonate, also known by the acronym “PC”, or a visor of a motorcycle helmet, and the acoustically conductive portion can be secured, for example removably, to the acoustically insulating portion.

In addition, the optical surface can comprise a monolayer or multilayer coating covering one face of the acoustically conductive portion.

The coating can in particular comprise a hydrophobic layer, an anti-reflective layer, or a stack of these layers. For example, the hydrophobic layer consists of OTS self-assembled monolayers or can be produced by deposition of a fluorine-based plasma. The coating can comprise one or more anti-reflective layers depending on the intended application (visible, IR, etc.).

Preferably, the optical surface is made from a material other than a piezoelectric material.

Preferably, the optical surface is selected from the group consisting of:
a motor vehicle surface, for example a glazing element of a motor vehicle selected from a windshield of a vehicle, a rear window, the glazing of a rear-view mirror, or
a visor of a helmet,
a window of a building,
a sensor, in particular selected from an optical sensor, a thermal sensor, an acoustic sensor, or a pressure or speed sensor, in particular a probe, for example a Pitot tube,
a protective element of such a sensor, and
a surface of an optical device, the optical device being selected for example from a camera lens and a lens of a pair of spectacles.

In addition, the device can comprise an electric current generator electrically connected to the transducer, so that the transducer converts the electric power supply signal into an ultrasonic wave.

The invention also relates to an apparatus comprising a device according to the invention and a sensor configured to receive and/or emit radiation through the optical surface. The apparatus is for example a motor vehicle, in particular autonomous.

The invention further relates to a method for cleaning an optical surface, the method comprising
a) supplying a device according to the invention,
b) spraying the optical surface with a washing liquid by means of the spraying unit,
c) synthesizing an ultrasonic wave propagating in the optical surface and suitable for displacing the washing liquid to a body arranged on one face of the support.

Preferably, the electric power supply to the transducer is maintained at least until the body is displaced on the optical surface with the washing liquid.

Preferably, the electric power supply to the transducer is maintained at least until the body is displaced from the optical surface with the washing liquid.

The body can be solid, for example dust, a greasy film, or a particle of dried mud. It can be liquid, for example taking the form of a drop or a layer. In addition, when a liquid is deposited on the optical surface other than by the spraying unit, for example when the liquid is precipitation, the transducer can generate a wave to displace the liquid on the surface without the spraying unit delivering any washing liquid.

The spraying unit is positioned so that the washing liquid comes into contact with the optical surface near the transducer. The distance between the zone in which the washing liquid comes into contact with the optical surface and the transducer is preferably less than 1 mm and/or the relative pressure of the washing liquid at the outlet of the spraying unit is preferably less than 1 bar. The method thus has good energy efficiency, as it does not require long-distance and/or high-pressure spraying of the washing liquid onto the optical surface.

Preferably, at least some of the electrical energy powering the electric transducer is converted into the form of heat by the transducer, the heat being sufficient to defrost the washing liquid previously contained in step b) in the spraying unit and/or to heat the washing liquid by more than 10° C., or even by more than 20° C., between the inlet and the outlet of the spraying unit.

The speed of heating the washing liquid by heating of the transducer can be greater than 2° C./s, preferably greater than 5° C./s.

In addition, the spraying can take place sequentially. The washing liquid can be delivered onto the optical surface in sequences of a duration of between 20 ms and 5 s, the sequences being spaced apart by a duration of between 50 ms and 60 s.

The washing liquid can be water-based and comprise washing agents. The washing liquid can further comprise agents that increase the hydrophobic properties of the optical surface.

The invention will be better understood on reading the following detailed description of non-limiting exemplary embodiments thereof, and from examining the appended drawing, in which:

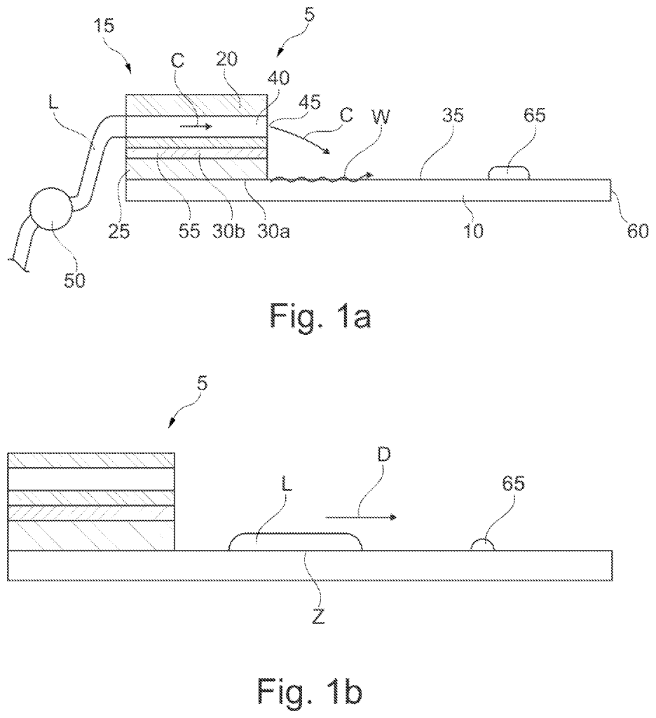

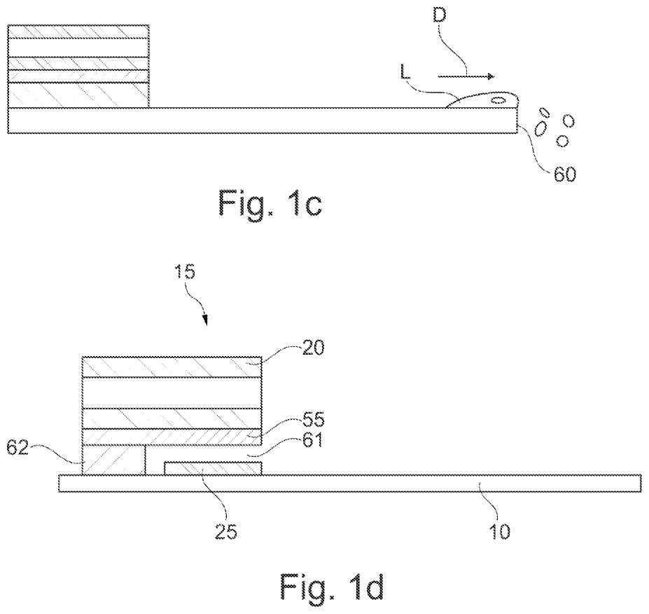

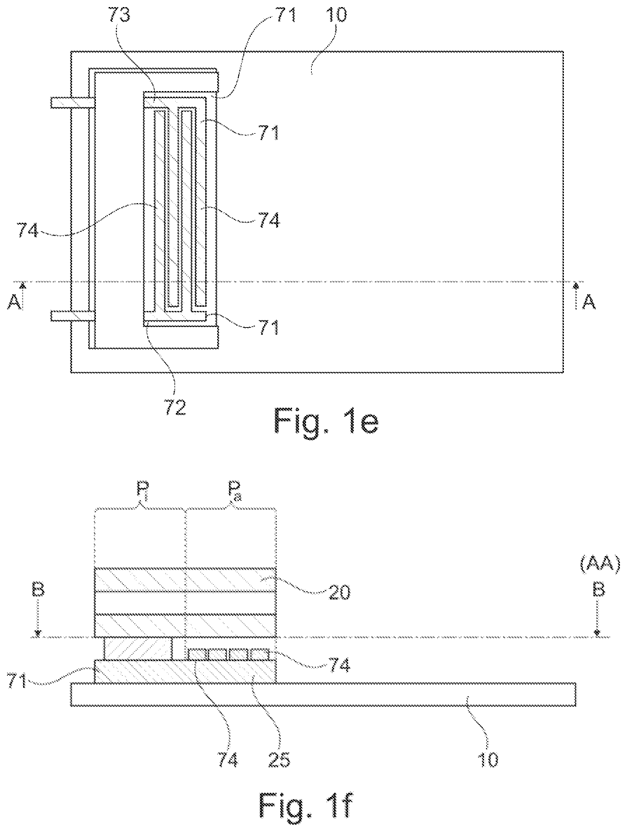

FIG. 1a

FIG. 1b and

FIG. 1c are schematic transverse cross-sections of a first example of a device according to the invention,

FIG. 1d is a variant of the first example of a device according to the invention,

FIG. 1e and

FIG. 1f are cross-sections along the line (BB) viewed from above and along the line (AA) viewed from the side respectively of another variant of the first example of a device according to the invention,

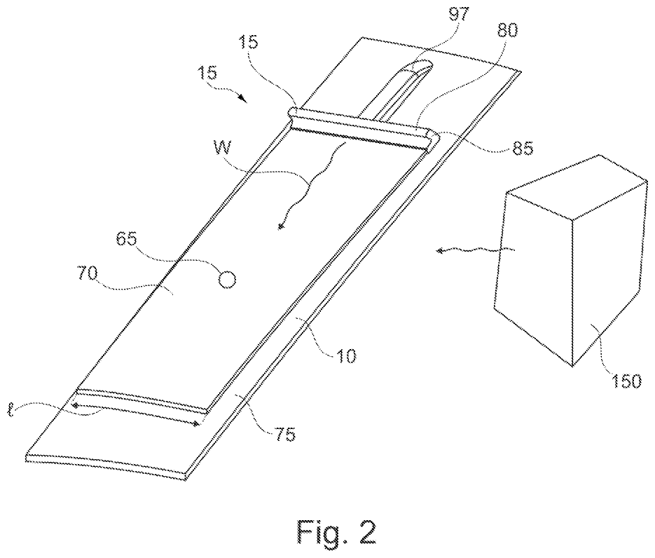

FIG. 2 is a perspective view of a second example of a device according to the invention,

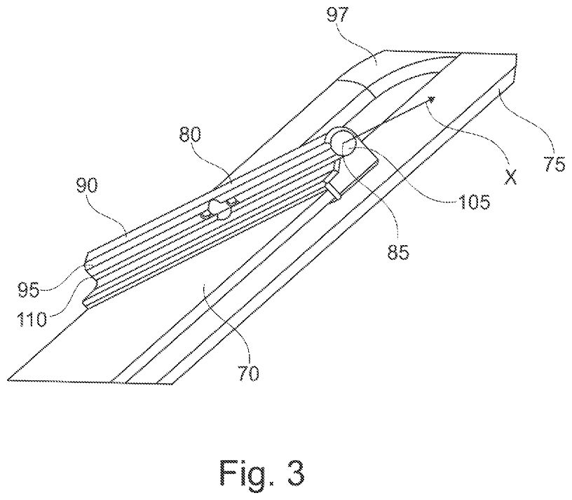

FIG. 3 is another enlarged perspective view of the second example, and

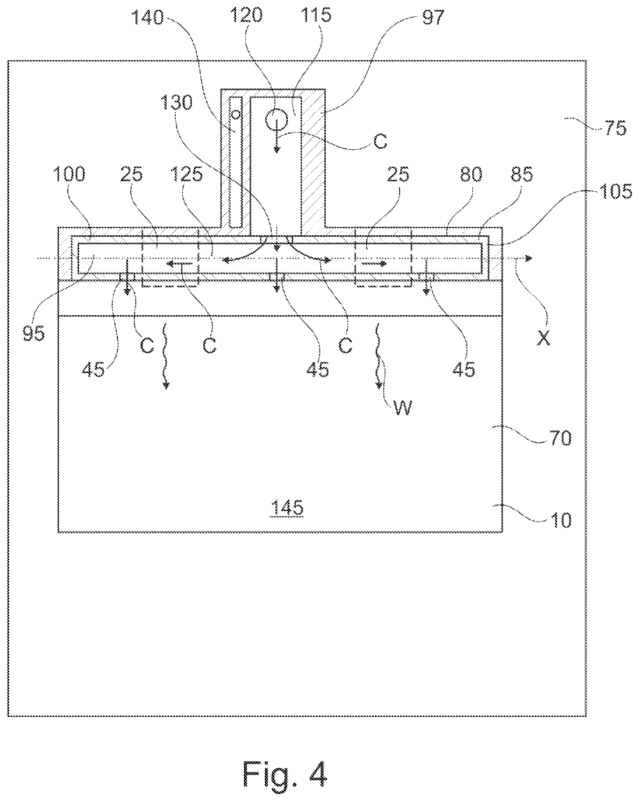

FIG. 4 is a schematic cross-section viewed perpendicular to the optical surface of the second example illustrated in FIGS. 2 and 3.

For the sake of clarity, the elements that make up the drawing are not always shown to scale.

FIGS. 1a to 1c illustrate a first example of a device 5 according to the invention. The device 5 comprises an optical surface 10, in the form of a plate, and a cleaning apparatus 15.

The cleaning apparatus 15 comprises a spraying unit 20 and a wave transducer 25 in contact with the optical surface 10. The transducer 25 is covered on each of its opposite faces 30a, 30b by the spraying unit 20 and by the optical surface 10, which protect it by sandwiching it.

The cleaning apparatus 15 can be arranged on the periphery of the optical surface 10.

The transducer 25 can be electrically connected to a current generator, not shown. When it is supplied with electric power, the transducer generates an ultrasonic wave W that propagates in the optical surface 10. The ultrasonic wave can be a Lamb wave or an ultrasonic surface wave that preferably propagates on the face 35 of the optical surface in contact with the transducer.

A supply channel 40 is made in the spraying unit 20 in order to convey, as indicated by the arrow C, a washing liquid L from a tank to a distribution orifice 45 that emerges onto the optical surface.

The device can comprise a pump 50 in order to transport the washing liquid L to the distribution orifice 45.

The supply channel 40 can be superposed on the transducer 25 and be at a distance of less than 30 mm. The washing liquid L contained in the supply channel 40 can thus be heated by the heat dissipated by Joule heating by the transducer. For optimum heating of the washing liquid, the spraying unit is preferably in contact with the transducer or with a thermal diffusion member 55 that is in contact with the transducer 25. The device in the example illustrated comprises such a thermal diffusion member 55, for example made from aluminum, which covers the transducer, in order to efficiently diffuse the heat produced by the transducer to the supply channel.

To clean the optical surface, a predetermined volume of a washing liquid is conveyed, for example by transport by means of the pump 50, to the distribution orifice 45, through which it flows. It reaches the face 35 of the optical surface to which the cleaning apparatus is secured. The transducer generates an ultrasonic surface wave that propagates in the optical surface of the transducer towards an opposite edge 60 of the optical surface, along a propagation path that passes through the zone Z of the optical surface covered by the washing liquid.

The washing liquid is then moved away from the transducer, as indicated by the arrow D, under the action of the ultrasonic wave on the optical surface. The washing liquid can thus meet a body 65, such as dust or a greasy particle, adhering to the optical surface. The body can then be dissolved in the washing liquid, as illustrated in FIG. 1c, and driven off the optical surface via the edge 60.

Advantageously, the entire volume of washing liquid deposited by the spraying unit onto the optical surface can be evacuated under the effect of the propagation of the ultrasonic wave W. This thus avoids the formation of a residual film resulting from the evaporation of the washing liquid not evacuated from the optical surface.

The optical surface of the device illustrated in FIGS. 1a to 1c is shown horizontally, but it can obviously be oblique or vertical without affecting the operating efficiency of the device.

In a variant embodiment illustrated in FIG. 1d, a slot 61 can be made between the transducer 25 and the thermal diffusion member 55 in order to separate the transducer from the thermal diffusion member. This exemplary embodiment is preferred when the thickness of the transducer is less than the wavelength of the ultrasonic wave generated by the transducer, for example when the thickness of the transducer is less than 50 μm. The thermal diffusion member of the transducer can be secured, for example bonded, to an acoustically insulating element 62, for example made from a thermoplastic, secured to the optical surface 10 and thicker than the transducer.

FIGS. 1e and 1f illustrate another example of a device according to the invention, which differs in particular from the device illustrated in FIG. 1d in that the transducer comprises a piezoelectric substrate 71 and two electrodes with opposite polarity in contact with the substrate. The electrodes are each in the form of a comb 72 comprising a connector 73 and fingers 74 that extend perpendicularly from the connector. The fingers of the combs are interconnected. When the electrodes are supplied with electric power, the difference in polarity thus generates the vibration of the piezoelectric substrate 71 in the portion Pa of the substrate delimited by the peripheral combs, which results in the generation of the ultrasonic wave. The piezoelectric substrate is extended outside the assembly delimited by the peripheral fingers of the combs, and thus defines an inactive portion Pi of the transducer, in which no wave is directly generated by supplying electric power to the electrodes. As illustrated in FIGS. 1e and 1f, the thermal diffusion member is secured to the inactive portion Pi of the piezoelectric substrate and a slot is made between the transducer and the spraying unit, by means of the thermal diffusion member, which is sufficiently thick to space apart the combs of the spraying unit. The heat produced by the heating of the transducer can thus be transferred efficiently by conduction through the thermal diffusion member to the washing liquid circulating in the spraying unit. Preferably, in order to avoid the formation of a short circuit when the electrodes are supplied with electric power, the thermal diffusion member is separated from the combs by a distance greater than the wavelength of the ultrasonic wave.

FIGS. 2 to 4 show a second exemplary embodiment of the device according to the invention.

The device 15 differs in particular from the device illustrated in FIG. 1a in that the optical surface 10 comprises two portions 70, 75 stacked one on top of the other and having faces in contact with each other having complementary shapes.

The first portion 70 is acoustically conductive and is intended to propagate an ultrasonic wave W. This first portion 70 is attached to a second portion 75 with a larger area, which is for example a windshield of a motor vehicle.

The second portion 75 can be acoustically insulating as it is not intended to propagate the ultrasonic wave generated by the transducer.

The first portion 70 can be removably secured to the second portion 75, for example by means of a layer of heat-sensitive adhesive. If one or other of these two portions breaks, it is thus easy to replace the damaged portion.

In addition, the device illustrated in FIGS. 2 to 4 also differs from the device illustrated in FIGS. 1a to 1c in that the sprayer unit comprises a structure 80 and a sprinkler nozzle 85 housed in the structure.

The structure 80 comprises an arm 90 that extends, like the sprinkler nozzle, along the entire width 1 of the first portion 70. The arm comprises a straight groove 95 with an axis X and the transverse cross-section of which has an arc-shaped contour. The structure can further comprise a foot 97, in contact with the second portion 75, which extends from the arm, perpendicular thereto.

In the example illustrated in FIG. 4, the device comprises one or more transducers 25 for generating ultrasonic waves that are in contact with the first acoustically conductive portion 70 and entirely covered by the arm 90.

The sprinkler nozzle 85 is housed in the groove 95. It is rotatable about the axis X in the groove relative to the structure. It can be held by the structure so that it is translatably fixed along the axis X relative to the structure.

The sprinkler nozzle 85 can be a cylindrical tube with an axis of rotation X comprising a wall 100 the shape of the radially outer face of which complements the shape of the groove. The tube can be closed at its opposite ends 105, 110 along the axis X.

In addition, the structure 80 and the sprinkler nozzle 85 are in fluid communication in order to convey the washing liquid L from a tank to the optical surface 10.

The structure can comprise a slot 115 made in the foot 97 that emerges into the groove 95 at one of its ends and into a hole 120 passing through the thickness of the second portion at another of its ends. The washing liquid can be introduced into the structure by means of the hole 120.

The sprinkler nozzle 85 can comprise a hollow inner space 125, an opening 130 made in the wall that emerges onto the slot 115 and one or more distribution orifices 45 made in the wall that emerge onto the optical surface 10. The inner space 125 is preferably superposed on the transducers 25, shown in dashed lines.

The slot 115 and the inner space 125 placed in fluid communication by the opening 130 thus define a channel for supplying washing liquid.

As indicated by the arrows C in FIG. 4, the washing liquid L thus flows from the hole 120 into the supply channel, where it is heated by the heat emitted by the transducers 25. It is then distributed onto the optical surface through the distribution orifices 45.

The washing liquid is then displaced by the ultrasonic wave generated by the transducer on the optical surface in order to clean it, as illustrated previously in FIGS. 1a to 1c.

In addition, the spraying unit can comprise a motor for arranging the sprinkler nozzle 85 in a specific angular position about the axis X.

The structure can comprise one or more ducts 140 in which electric cables can be housed, in order to electrically connect the transducer(s) and/or the motor to an electricity generator.

Advantageously, the device illustrated in the second example makes it possible to efficiently clean the face 145 of the first portion, for example in order to make it possible for an apparatus 150, as illustrated in FIG. 2, to emit and/or receive radiation through this first portion.

Of course, the invention is not limited to the exemplary embodiments of the invention given by way of non-limiting illustration.

1. A device comprising:
an optical surface; and
an apparatus for cleaning the optical surface, the device comprising:
a wave transducer acoustically coupled to the optical surface and configured to synthesize an ultrasonic wave propagating in the optical surface; and
a spraying unit for delivering a washing liquid onto the optical surface, the spraying unit being superposed on the transducer,
the device being configured so that the ultrasonic wave displaces the washing liquid on the optical surface.

2. The device as claimed in claim 1,
the spraying unit being secured to the optical surface and/or to the transducer.

3. The device as claimed in claim 1,
the transducer being arranged between the spraying unit and the optical surface.

4. The device as claimed in claim 1,
the spraying unit being configured to deliver the washing liquid onto a zone of the optical surface situated on the propagation path of the ultrasonic wave.

5. The device as claimed claim 1,
the spraying unit comprising a channel for supplying washing liquid at least partially superposed on the transducer and distant less than 4 cm from the transducer.

6. The device as claimed in claim 1,
the cleaning apparatus comprising a thermal diffusion member, arranged between the transducer and the spraying unit, made from a material having thermal conductivity greater than or equal to 50 W.m⁻¹.K⁻¹.

7. The device as claimed in claim 1, the cleaning apparatus being arranged on the periphery of the optical surface.

8. The device as claimed in claim 1, the spraying unit being configured to deliver the washing liquid sequentially.

9. The device as claimed in claim 1, the transducer having a thickness of between 1 μm and 500 μm.

10. The device as claimed in claim 1, the optical surface being a glazing element of a motor vehicle.

11. The device as claimed in claim 1,
the spraying unit being configured to deliver the washing liquid at a relative pressure of less than 1 bar.

12. A method for cleaning an optical surface,
the method comprising:
a) supplying a device as claimed in claim 1,
b) spraying the optical surface with a washing liquid by the spraying unit,
c) synthesizing an ultrasonic wave propagating in the optical surface and suitable for displacing the washing liquid to a body arranged on one face of the support.

13. The method as claimed in claim 12,
the electric power supply to the transducer being maintained at least until the body is displaced on the optical surface with the washing liquid.

14. The method as claimed in claim 12,
the distance between the zone in which the washing liquid comes into contact with the optical surface and the transducer being less than 1 mm and/or the relative pressure of the washing liquid at the outlet of the spraying unit being less than 1 bar.

15. The method as claimed in claim 12,
at least some of the electrical energy powering the electric transducer being converted into the form of heat by the transducer, the heat being sufficient to defrost the washing liquid previously contained in step b) in the spraying unit and/or to heat the washing liquid by more than 10° C. between the inlet and the outlet of the spraying unit.
